(19) United States
(12) Patent Application Publication
(10) Pub. No.: US 2020/0113386 A1
(43) Pub. Date: Apr. 16, 2020

(54) MULTIPLE SPICE GRINDER

(71) Applicant: DREAMBIZ LTD., Tsim Sha Tsui (HK)

(72) Inventor: RAJENDRA SOBHA NAGRANI, Hong Kong (HK)

(21) Appl. No.: 16/597,020

(22) Filed: Oct. 9, 2019

Related U.S. Application Data
(60) Provisional application No. 62/745,450, filed on Oct. 14, 2018.

(51) Int. Cl. A47J 42/50; A47J 42/34

(52) U.S. Cl. CPC A47J 42/50; A47J 42/34

(57) ABSTRACT

Embodiments of the present disclosure are directed to a multi-compartment spice grinder. The grinder comprises a container having a hollow receiving space for receiving a multi-partition component allowing the grinder to be filled with a different whole kernel spices in each compartment. An upper cap may be received over the container and a grinding mechanism may be secured to the upper cap. In operation, the multi-partition component is rotatable within the container allowing a user to select which compartment, and subsequently which spice, will engage the grinding mechanism when the grinder is inverted. When inverted the selected spice rests on the grinding mechanism, in a manner such that when the spice grinder is activated the spices engage the grinding mechanism and ground spices fall through an outlet of the grinding mechanism by gravity flow.

### FIELD

This present disclosure relates to hand-held manual spice grinders and more specifically a multi-compartment spice grinder where each compartment may contain a different whole kernel spice allowing a user to select a spice from multiple spices to grind.

### BACKGROUND

Often times when eating it is desirable to enhance the taste experience by flavoring foods with measured quantities of spices of exacting taste. With the popularity of cooking shows and the abundance of restaurants, individuals have become more adept at combining various spices and recognizing the subtle differences between fresh ground spices and stored ground spices, with more and more people requesting and requiring the use of fresh ground spices in the preparation of foods.

A common kitchen tool to obtain fresh ground spices is a spice grinder. The spice grinder is a single purpose device purchased for the sole purpose of grinding large kernels of spices, such as pepper corn, into fresh ground smaller particles that is sprinkled over or into the food. The spice grinder, periodically re-filled with whole kernels of spices, generally comprises a grinding mechanism proximate an outlet to allow ground pepper, for example, to escape from the outlet as it is being ground. With some grinders the grinder is inverted so the open end faces downward and the pepper corn rests on the grinding mechanism, in a manner such that when the grinder is activated the large kernels of pepper engage the grinding mechanism and ground pepper falls through the outlet by gravity flow.

With the growing availability of spices that can be purchased in whole form in bulk at specialty grocery stores and on-line, for example, and the ever increasing sophisticated palettes of individuals demanding fresh ground spices, what is needed is spice grinder that contains multiple compartments allowing the user to grind more than one spice from the same spice grinder.

### SUMMARY

The following presents a simplified summary of one or more implementations in order to provide a basic understanding of some implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

According to one embodiment, a multi-compartment spice grinder is provided. The multi-compartment spice grinder comprises a container comprising a cylindrical sidewall having an upper end and a lower end, the cylindrical sidewall forming a hollow receiving space; a multi-partition component received within the hollow receiving space of the container; the multi-partition component having a plurality of walls forming separate compartments; a bottom stopper configured to be received with the container, the bottom stopper having a plurality of slits configured to receive the plurality of walls; a upper cap configured to be received over the container, the upper cap having a lower portion integrally connected to a lower portion; a grinding mechanism secured to and extending outward from the upper cap; and a lower cap threadingly engaged with the lower end of the container.

According to one aspect, each compartment formed by the multi-partition component is filled with a different whole kernel spice.

According to another aspect, the multi-partition component comprises a plurality of elongated walls, each elongated wall in the plurality of walls comprises a horizontal bottom wall member, a first vertical side member extending upwardly from a first end of the bottom wall member and a second vertical side member extending perpendicularly upward from a second end of the bottom wall member.

According to another aspect, the second vertical side member of each elongated wall in the plurality of walls is integrally connected to form the multi-partition component.

According to another aspect, the grinding mechanism comprises: a static component integrally connected to an upper portion of the upper cap; a grinding knob rotatably secured to the upper portion of the cap; and a top cap releasably secured within the grinding knob.

According to another aspect, the rotatable component is a grinding knob and wherein the grinding mechanism comprises an inner grinder located within an outer grinder.

According to another aspect, the inner and outer grinders are located in an end knob for securing to the static component of the grinding mechanism.

According to another aspect, the outer grinder includes an inversion hole for receiving a shaft, the shaft further extends through an insertion hold in the inner grinder which is secured to the shaft.

According to another aspect, a greater distance between the inner and outer grinders larger pieces of the ground spices are obtained.

According to another feature, a multi-compartment spice grinder is provided. The multi-compartment spice grinder comprises a container comprising a cylindrical sidewall having an upper end and a lower end, the cylindrical sidewall forming a hollow receiving space; a multi-partition component received within the hollow receiving space of the container, the multi-partition component having a plurality of walls forming separate compartments; a bottom stopper configured to be received with the container, the bottom stopper having a plurality of slits configured to receive the plurality of walls; a upper cap configured to be received over the container, the upper cap having a lower portion integrally connected to a lower portion; a grinding mechanism secured to and extending outward from the upper cap, the grinding mechanism comprises: a static component integrally connected to an upper portion of the upper cap; a rotatable component rotatably secured to the upper portion of the cap; and a top cap secured within the rotatable component; and a lower cap threadingly engaged with the lower end of the container.

According to an aspect, each compartment formed by the multi-partition component is filled with a different whole kernel spice.

According to another aspect, the multi-partition component comprises a plurality of elongated walls, each elongated wall in the plurality of walls comprises a horizontal bottom wall member, a first vertical side member extending upwardly from a first end of the bottom wall member and a second vertical side member extending perpendicularly upward from a second end of the bottom wall member.

According to another aspect, the multi-compartment spice grinder further comprises a clutch mechanism for a compartment formed by the plurality of walls, the clutch mechanism comprising: a first clutch; a second clutch secured in the first clutch; and a spring located below a bottom of the first clutch.

According to another aspect, the multi-partition component comprises a plurality of elongated walls, each elongated wall in the plurality of walls comprises a horizontal bottom wall member, a first vertical side member extending upwardly from a first end of the bottom wall member and a second vertical side member extending perpendicularly upward from a second end of the bottom wall member.

According to another aspect, the second vertical side member of each elongated wall in the plurality of walls is integrally connected to form the multi-partition component.

According to another aspect, the rotatable component is a grinding knob and wherein the grinding mechanism comprises an inner grinder located within an outer grinder.

According to yet another feature, a multi-compartment spice grinder is provided. The spice grinder comprises a container comprising a cylindrical sidewall having an upper end and a lower end, the cylindrical sidewall forming a hollow receiving space; a multi-partition component received within the hollow receiving space of the container, the multi-partition component having a plurality of walls forming separate compartments; a clutch mechanism for a compartment formed by the plurality of walls, the clutch mechanism comprises: a first clutch; a second clutch secured in the first clutch; and a spring located below a bottom of the first clutch; and a bottom stopper configured to be received with the container, the bottom stopper having a plurality of slits configured to receive the plurality of walls; a upper cap configured to be received over the container, the upper cap having a lower portion integrally connected to a lower portion; a grinding mechanism secured to and extending outward from the upper cap, the grinding mechanism comprises: a static component integrally connected to an upper portion of the upper cap; a rotatable component rotatably secured to the upper portion of the upper cap; and a top cap secured within the rotatable component; and a lower cap threadingly engaged with the lower end of the container wherein the rotatable component is a grinding knob and wherein the grinding mechanism comprises an inner grinder located within an outer grinder.

According to another aspect, the multi-partition component comprises a plurality of elongated walls, each elongated wall in the plurality of walls comprises a horizontal bottom wall member, a first vertical side member extending upwardly from a first end of the bottom wall member and a second vertical side member extending perpendicularly upward from a second end of the bottom wall member.

According to another aspect, the second vertical side member of each elongated wall in the plurality of walls is integrally connected to form the multi-partition component.

### BRIEF DESCRIPTION OF THE DRAWINGS

The features, nature, and advantages of the present aspects may become more apparent from the detailed description set forth below when taken in conjunction with the drawings in which like reference characters identify correspondingly throughout.

FIG. 1 is a front, top right side perspective view of a multi-compartment spice grinder of the present disclosure in a fully assembled configuration.

FIG. 2 is an environmental view of the multi-compartment spice grinder of FIG. 1.

FIG. 3A is an exploded view of the multi-compartment spice grinder of FIG. 1, according to one embodiment.

FIG. 3B is an exploded view of the multi-compartment spice grinder of FIG. 1, according to one embodiment.

FIG. 4 is a right side elevational view of the multi-compartment spice grinder of FIG. 1.

FIG. 5 is a cross-sectional view taken along line 5-5 in FIG. 4.

FIG. 6 is a top plan view of the multi-compartment spice grinder of FIG. 1.

FIG. 7A is a cross-sectional view taken along line 7-7 in FIG. 6, according to one embodiment.

FIG. 7A is a cross-sectional view taken along line 7-7 in FIG. 6, according to one embodiment.

FIG. 7B is a cross-sectional view taken along line 7-7 in FIG. 6, according to another embodiment.

### DETAILED DESCRIPTION

The present disclosure will now be described in detail with reference to the accompanying drawings. In the following description, numerous specific details are set forth in order to provide a thorough understanding of the aspects described herein. It will be apparent, however, to one skilled in the art, that these and other aspects may be practiced without some or all of these specific details. In other instances, well known process steps and/or structures have not been described in detail in order to not unnecessarily obscure the description.

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation.

### Overview

Exemplary embodiments of the present disclosure are directed to a multi-compartment spice grinder. The spice grinder comprises a container having a hollow receiving space for receiving a multi-partition component allowing the spice grinder to be filled with a different whole kernel spices in each compartment. An upper cap may be configured to be received over the container and a grinding mechanism may be secured to the upper cap. In operation, the multi-partition component is rotatable within the container allowing a user to select which compartment, and subsequently which spice, will engage a grinding mechanism. The whole kernel spices engage the grinding mechanism when the spice grinder is inverted allowing openings in the container to face downward and allows the whole kernel spices in the selected compartment to rest on the grinding mechanism, in a manner such that when the spice grinder is activated the whole spice kernels engage the grinding mechanism and ground spices fall through an outlet of the grinding mechanism by gravity flow.

### Multi-Compartment Spice Grinder

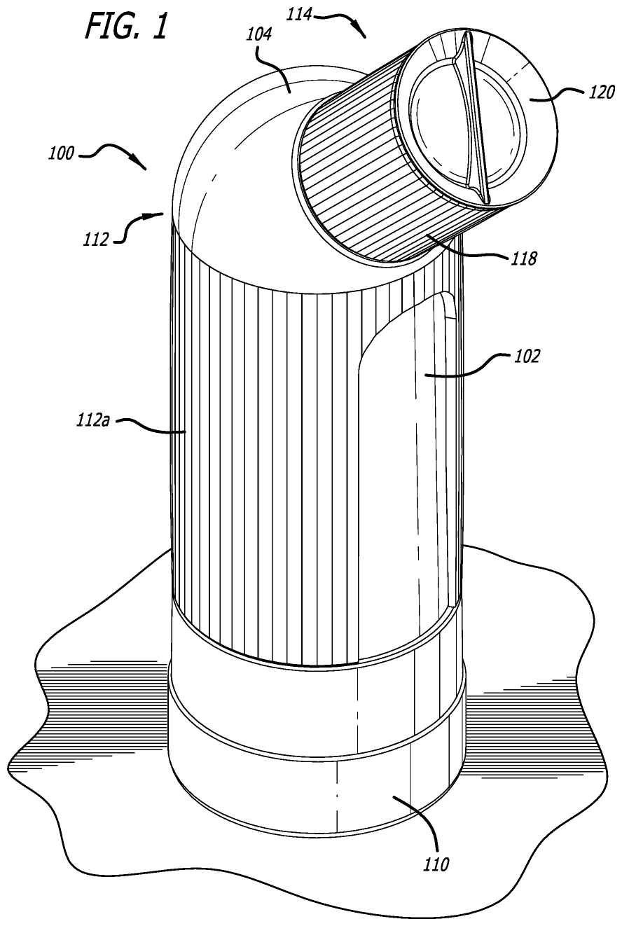

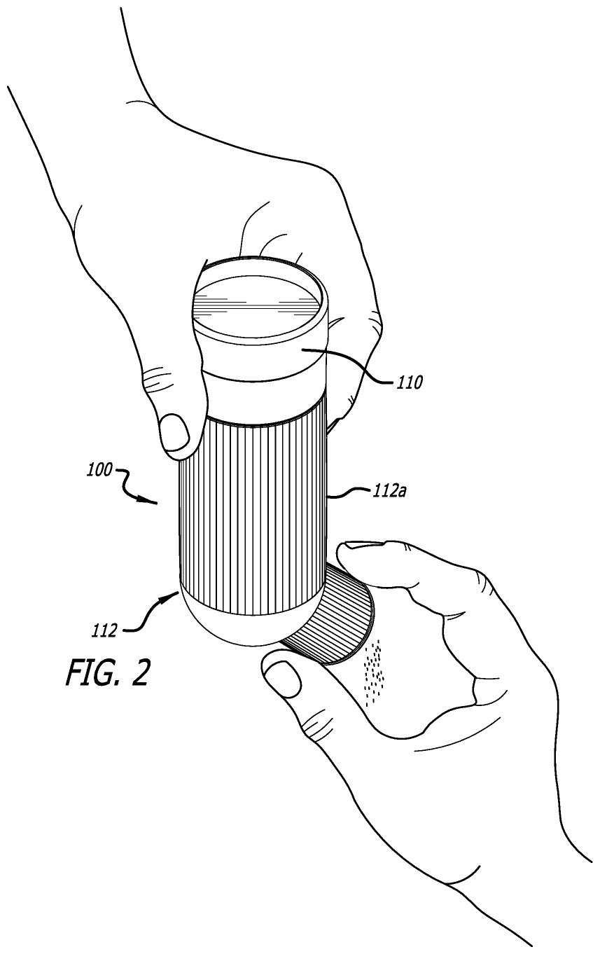

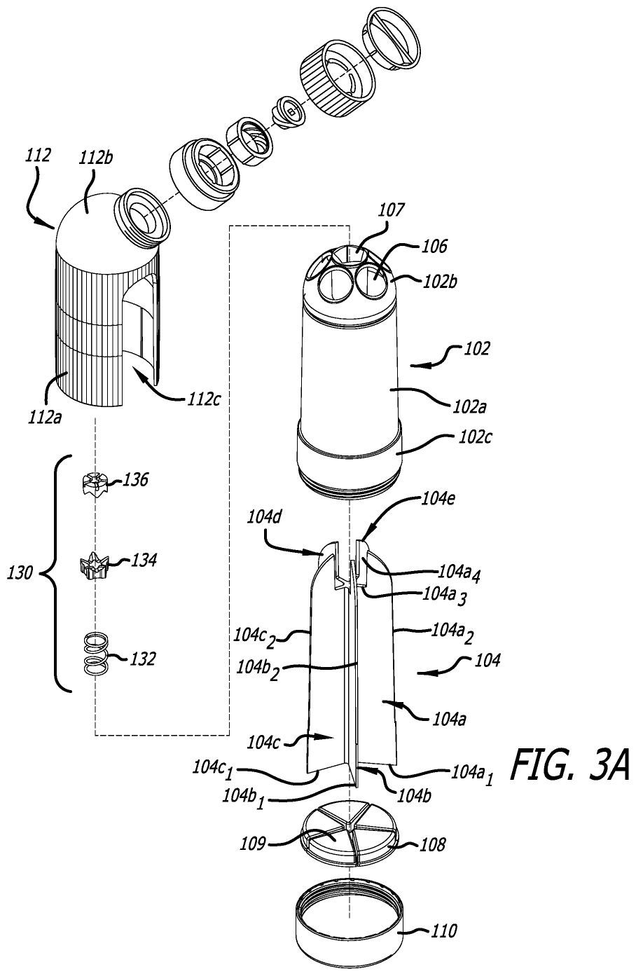

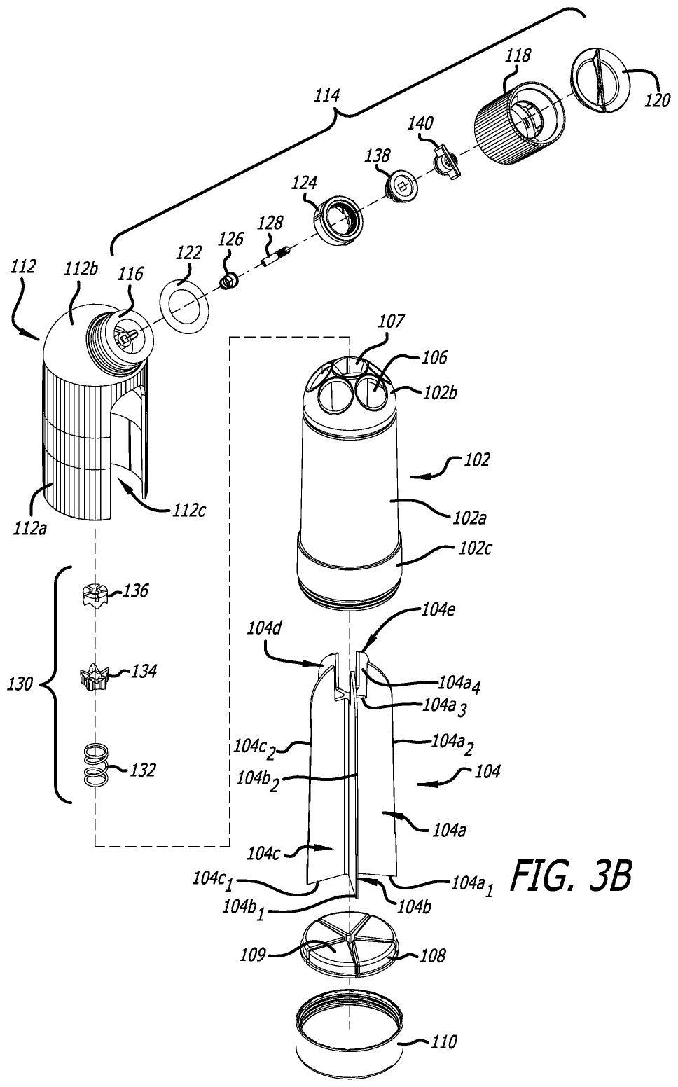

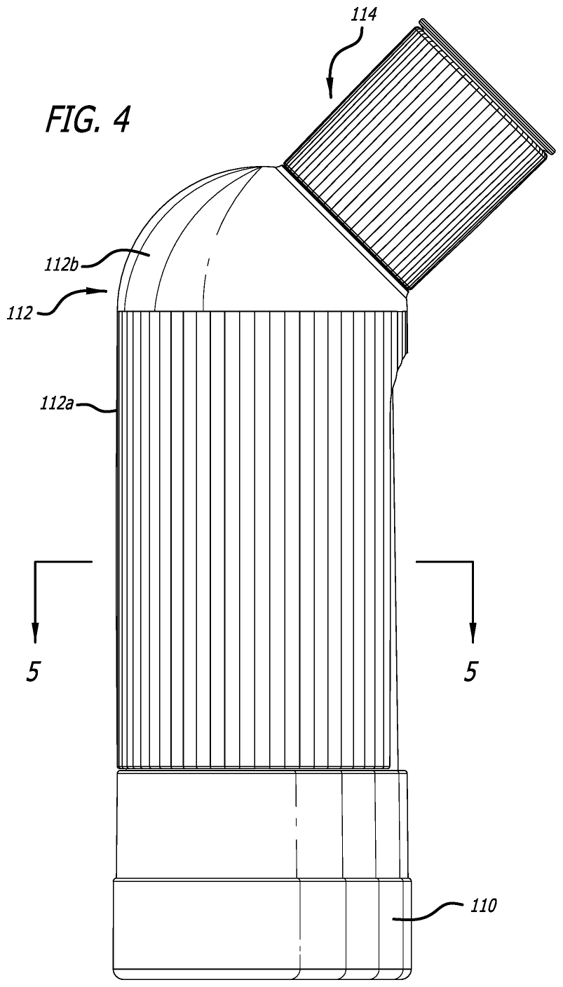

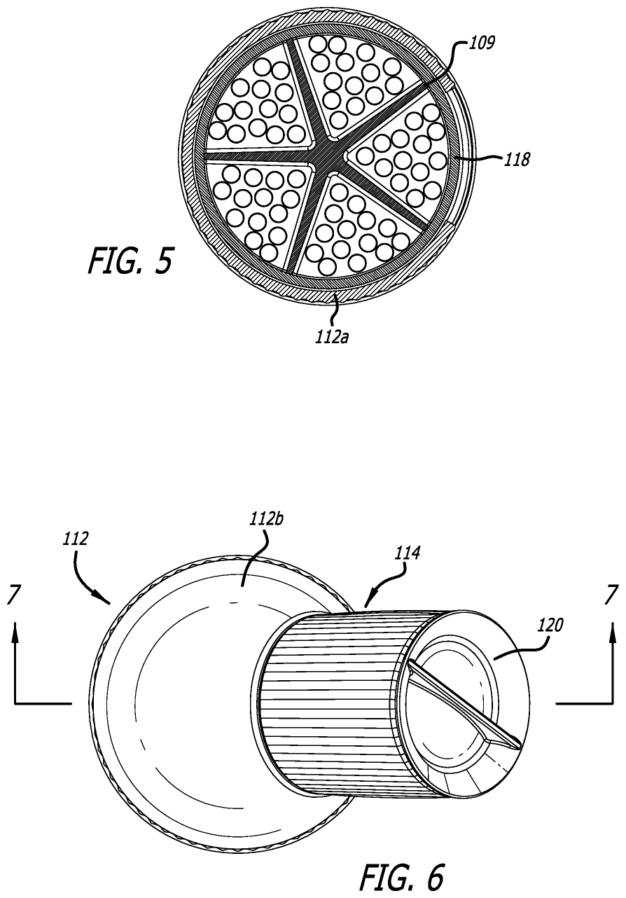

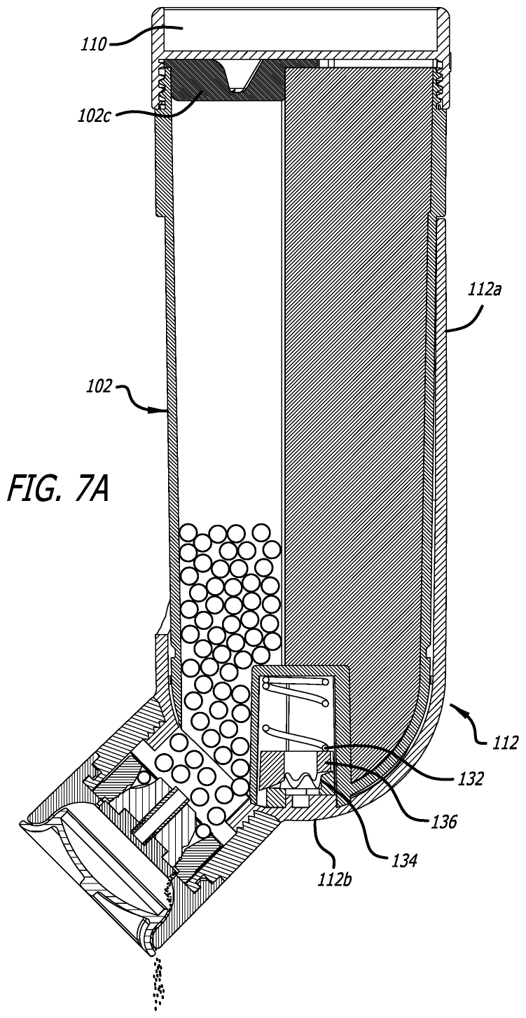

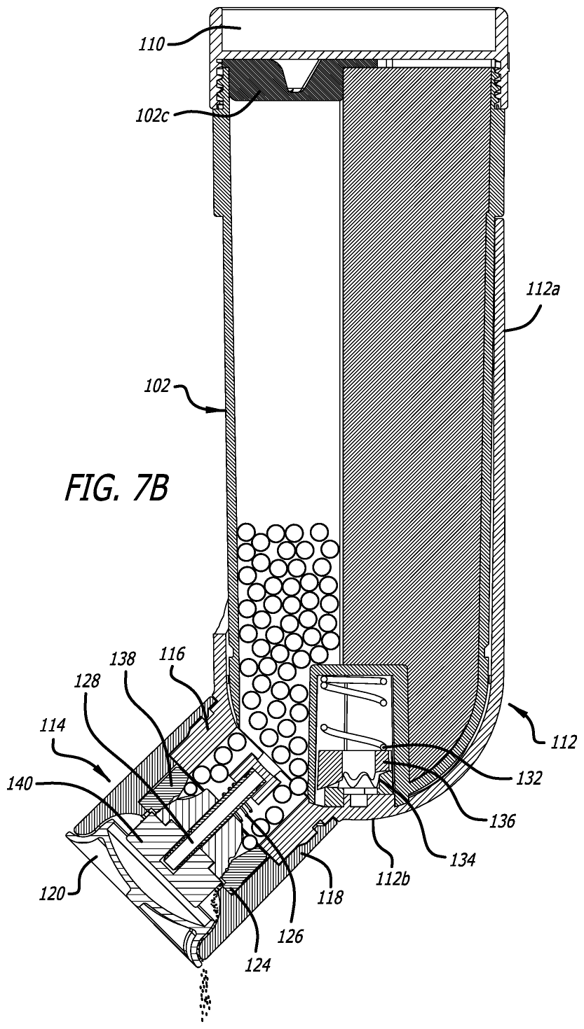

FIG. 1 is a front, top right side perspective view of a multi-compartment spice grinder 100 of the present disclosure in a fully assembled configuration. FIG. 2 is an environmental view of the multi-compartment spice grinder of FIG. 1. FIG. 3A is an exploded view of the multi-compartment spice grinder of FIG. 1, according to one embodiment. FIG. 3B is an exploded view of the multi-compartment spice grinder of FIG. 1, according to one embodiment. FIG. 4 is a right side elevational view of the multi-compartment spice grinder of FIG. 1. FIG. 5 is a cross-sectional view taken along line 5-5 in FIG. 4. FIG. 6 is a top plan view of the multi-compartment spice grinder of FIG. 1. FIG. 7A is a cross-sectional view taken along line 7-7 in FIG. 6, according to one embodiment. FIG. 7B is a cross-sectional view taken along line 7-7 in FIG. 6, according to another embodiment. The following discussion refers interchangeably to FIGS. 1-7B.

As shown, the multi-compartment spice grinder 100 may include a container 102 having a hollow receiving space formed by a cylindrical sidewall 102a located between an upper sidewall end 102b and a lower sidewall end 102c. A multi-partition structure 104 (See FIG. 3) may be configured to be received into the hollow receiving space of the container 102 from the lower sidewall end 102c having an opening. The multi-partition component 104 may be comprised of a plurality of elongated walls 104a-104e integrally connected along a side forming a plurality of different compartments. The elongated walls 104a-104e create separate compartments or areas within the container 102 where each compartment may be used for a storing different spice pellets or kernels for grinding.

Each of the elongated walls 104a-104e has a horizontal bottom wall member (104a₁-104e₁), a first side vertical member (104a₂-104e₂) and an opposing second side vertical member. The first vertical side wall member of each elongated wall may extend upwardly in a slightly inward direction and having a curved shaped end with a notch in it. The notch is formed by a bottom horizontal notch wall member (104a₃, for example) and a side vertical notch wall member (104a₄, for example) extending perpendicularly upward form the bottom horizontal notch wall. The second vertical member extends perpendicularly upward from the horizontal bottom wall member to the bottom horizontal notch wall member. Although five (5) elongated walls are shown forming five (5) compartments, this is by way of example only. The multi-partition device 104 may include less than five (5) elongated walls or more than five (5) elongated walls.

According to one aspect, the upper end 102b may have a generally circular configuration having a top opening 107 surrounded by a plurality of side openings 106 located around the circular end. Each of the notches, described above, correspond with one of the plurality of side openings 106. In operation, the multi-partition component 104 may be rotatable within the container 102 allowing a user to select which compartment, and subsequently which spice, will engage a grinding mechanism, described below, and be ground into smaller pieces. The selected whole kernel spice will exit the top opening to engage the grinding mechanism. In other words, there is a separate side opening in the plurality of side openings 106 that corresponds to each compartment which may be filled with whole spice kernels which are the same or different than the whole spice kernels in the other compartments.

A bottom stopper 108 may be placed over or received within the lower end 102c of the container 102 to maintain the spice pellets in the proper compartment of the container 102. Conversely, the bottom stopper 108 may be removed allowing for the compartments to be re-filled with spices. As shown in FIG. 3, the bottom stopper 108 may include a plurality of slots 109 which correspond to the elongated walls of the multi-partition component 104 so that the bottom of each elongated wall may be configured to fit within a slot. The bottom stopper 108 may be may be inserted or received within the container 102 when in an assembled configuration.

A lower cap 110 may be configured to be threadingly engaged with the lower end 102c of the container 102. The lower cap 110 may be easily removed along with the bottom stopper 108 allowing a user to fill each compartment of the container with the desired whole spice pellets or kernels.

An upper cap 112 may be configured to be received over the container 102. The upper cap 112 may comprise a lower portion 112a in the form of a cylindrical sidewall that is integrally connected to an upper portion 112b which may be in the form of a dome shaped configuration.

FIG. 3A in one example the upper cap 112 may include an elongated vertical side hole 112c which allows a user to see which spice will be engaging the grinding mechanism.

The multi-compartment spice grinder 100 may further include a clutch mechanism 130 for locking the compartment with the whole spice pellets or kernels in place so that the whole spice kernels engage with the grinding mechanism allowing the user to only receive the ground spice that was selected to be ground. As shown in FIG. 3A in an unassembled configuration, the clutch mechanism may include a spring 132, a first gear or clutch 134 and a second gear or clutch 136. As shown in FIG. 4 in an assembled configuration, the clutch mechanism 130 is located within a top opening 107 of the container 102. The clutch mechanism works 130 automatically to lock a compartment in the container 102 in place once the user has stopped turning the multi-partition component 104.

FIG. 3A also illustrates an exploded view of the grinding mechanism 115 of the spice grinder 100. The grinding mechanism 115 may be integrally connected to and extend outwardly from the upper portion 112a of the upper cap 112. The grinding mechanism 115 may comprise a static component 117 integrally connected to the upper portion 112b of the upper cap 112 and a rotatable component 129 rotatably secured to the upper portion 112b of the upper cap 112 and a top cap 121 which fits into the rotatable component (or grinding knob) 119. Located within the grinding knob 119 of the grinding mechanism 115 is an inner grinder 139 located within an outer grinder 137 for grinding the whole kernel spices into smaller pieces. The inner and outer grinders 139, 137 located in a knob 125 which may be screwed onto the static component 117 of the grinding mechanism 115.

The outer grinder 127 is located within the knob 125 which is secured to the static component 117 of the grinding mechanism 115. An outer grinder 137 includes an insertion hole in which the shaft 129 is passed through. The shaft 129 further extends through an insertion hole in an inner grinder 139 and is secured to the end of the shaft 129. The larger the distance between the inner and outer grinders 139, 137 the larger the pieces of the ground spices are. Conversely, the shorter the distance between the inner and outer grinders 138, 124 the smaller the pieces of the ground spices are.

The container 102 may be designed to contain a variety of different spice pellets. The container may be formed of glass, plastic or any other suitable material and may be transparent or translucent to permit viewing of the contents thereof.

The various features of the disclosure described herein can be implemented in different systems and devices without departing from the disclosure. It should be noted that the foregoing aspects of the disclosure are merely examples and are not to be construed as limiting the disclosure. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

FIG. 3B shows another one example of the upper cap 112 may include an elongated vertical side hole 112c which allows a user to see which spice will be engaging the grinding mechanism.

The multi-compartment spice grinder 100 may further include a clutch mechanism 130 for locking the compartment with the whole spice pellets or kernels in place so that the whole spice kernels engage with the grinding mechanism allowing the user to only receive the ground spice that was selected to be ground. As shown in FIG. 3 in an unassembled configuration, the clutch mechanism may include a spring 132, a first gear or clutch 134 and a second gear or clutch 136. As shown in FIG. 4 in an assembled configuration, the clutch mechanism 130 is located within a top opening 107 of the container 102. The clutch mechanism works 130 automatically to lock a compartment in the container 102 in place once the user has stopped turning the multi-partition component 104. In the clutch mechanism, the second clutch 136 is located or secured within the first clutch 134 while the spring 132 presses against the bottom of the first clutch 134. Based on the tension in the spring 132 the multi-partition component is rotatable within the container allowing a user to select which compartment, and subsequently which spice, will engage the grinding mechanism when the grinder is inverted.

FIG. 3B also illustrates an exploded view of the grinding mechanism 114 of the spice grinder 100, according to another embodiment. The grinding mechanism 114 may be integrally connected to and extend outwardly from the upper portion 112a of the upper cap 112. The grinding mechanism may comprise a static component 116 integrally connected to the upper portion 112b of the upper cap 112 and a rotatable component 118 rotatably secured to the upper portion 112b of the upper cap 112 and a top cap 120 which fits into the rotatable component (or grinding knob) 118. Located within the grinding knob 118 of the grinding mechanism 114 is an outer grinder 124 for grinding the whole kernel spices into smaller pieces. The outer grinder 124 is located on the static component 116, separated by a gasket 122. A spring 126 is placed over a shaft 128 which is rotatably secured to the static component 116. An outer grinder 138 includes an insertion hole in which the shaft 128 is passed through. The shaft 128 further extends through an insertion hole in an inner grinder 138 and an adjusting knob 140 is secured to the end of the shaft 128. The adjusting knob 140 can be rotated in a clockwise or counter-clockwise direction to adjust the size of the fresh ground spices by adjusting the distance between the inner and outer grinders 138, 124 on the shaft. The larger the distance between the inner and outer grinders 138, 124 the larger the pieces of the ground spices are. Conversely, the shorter the distance between the inner and outer grinders 138, 124 the smaller the pieces of the ground spices are. The compression and expansion of the spring 126 located on the shaft 128 allows for the adjustment of the inner and outer grinders 138, 124 on the shaft 128 to control the size of the ground spice pieces.

The container 102 may be designed to contain a variety of different spice pellets. The container may be formed of glass, plastic or any other suitable material and may be transparent or translucent to permit viewing of the contents thereof.

FIG. 7A is a cross-sectional view of the multi-compartment spice grinder in an un-exploded view taken along line 7-7 in FIG. 6, according to one embodiment.

FIG. 7B is a cross-sectional view of the multi-compartment spice grinder in an un-exploded view taken along line 7-7 in FIG. 6, according to one embodiment.

The various features of the disclosure described herein can be implemented in different systems and devices without departing from the disclosure. It should be noted that the foregoing aspects of the disclosure are merely examples and are not to be construed as limiting the disclosure. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

What is claimed is:

1. A multi-compartment spice grinder comprising:
a container comprising a cylindrical sidewall having an upper end and a lower end, the cylindrical sidewall forming a hollow receiving space;
a multi-partition component received within the hollow receiving space of the container, the multi-partition component having a plurality of walls forming separate compartments;
a bottom stopper configured to be received with the container, the bottom stopper having a plurality of slits configured to receive the plurality of walls;
a upper cap configured to be received over the container, the upper cap having a lower portion integrally connected to a lower portion;
a grinding mechanism secured to and extending outward from the upper cap; and
a lower cap threadingly engaged with the lower end of the container.

2. The multi-compartment spice grinder of claim 1, wherein each compartment formed by the multi-partition component is filled with a different whole kernel spice.

3. The multi-compartment spice grinder of claim 1, wherein the multi-partition component comprises a plurality of elongated walls, each elongated wall in the plurality of walls comprises a horizontal bottom wall member, a first vertical side member extending upwardly from a first end of the bottom wall member and a second vertical side member extending perpendicularly upward from a second end of the bottom wall member.

4. The multi-compartment spice grinder of claim 3, wherein the second vertical side member of each elongated wall in the plurality of walls is integrally connected to form the multi-partition component.

5. The multi-compartment spice grinder of claim 4, wherein the grinding mechanism comprises:
a static component integrally connected to an upper portion of the upper cap;
a grinding knob rotatably secured to the upper portion of the cap; and
a top cap releasably secured within the grinding knob.

6. The multi-compartment spice grinder of claim 5, wherein the rotatable component is a grinding knob and wherein the grinding mechanism comprises an inner grinder located within an outer grinder.

7. The multi-compartment spice grinder of claim 6, wherein the inner and outer grinders are located in an end knob for securing to the static component of the grinding mechanism.

8. The multi-compartment spice grinder of claim 7, wherein the outer grinder includes an inversion hole for receiving a shaft, the shaft further extends through an insertion hold in the inner grinder which is secured to the shaft.

9. The multi-compartment spice grinder of claim 8, wherein a greater distance between the inner and outer grinders larger pieces of the ground spices are obtained.

10. A multi-compartment spice grinder comprising:
a container comprising a cylindrical sidewall having an upper end and a lower end, the cylindrical sidewall forming a hollow receiving space;
a multi-partition component received within the hollow receiving space of the container, the multi-partition component having a plurality of walls forming separate compartments;
a bottom stopper configured to be received with the container, the bottom stopper having a plurality of slits configured to receive the plurality of walls;
a upper cap configured to be received over the container, the upper cap having a lower portion integrally connected to a lower portion;
a grinding mechanism secured to and extending outward from the upper cap, the grinding mechanism comprises:
a static component integrally connected to an upper portion of the upper cap;
a rotatable component rotatably secured to the upper portion of the cap; and
a top cap secured within the rotatable component; and
a lower cap threadingly engaged with the lower end of the container.

11. The multi-compartment spice grinder of claim 10, wherein each compartment formed by the multi-partition component is filled with a different whole kernel spice.

12. The multi-compartment spice grinder of claim 10, wherein the multi-partition component comprises a plurality of elongated walls, each elongated wall in the plurality of walls comprises a horizontal bottom wall member, a first vertical side member extending upwardly from a first end of the bottom wall member and a second vertical side member extending perpendicularly upward from a second end of the bottom wall member.

13. The multi-compartment spice grinder of claim 10, further comprising a clutch mechanism for a compartment formed by the plurality of walls, the clutch mechanism comprising:
a first clutch;
a second clutch secured in the first clutch; and
a spring located below a bottom of the first clutch.

14. The multi-compartment spice grinder of claim 10, wherein the multi-partition component comprises a plurality of elongated walls, each elongated wall in the plurality of walls comprises a horizontal bottom wall member, a first vertical side member extending upwardly from a first end of the bottom wall member and a second vertical side member extending perpendicularly upward from a second end of the bottom wall member.

15. The multi-compartment spice grinder of claim 14, wherein the second vertical side member of each elongated wall in the plurality of walls is integrally connected to form the multi-partition component.

16. The multi-compartment spice grinder of claim 14, wherein the rotatable component is a grinding knob and wherein the grinding mechanism comprises an inner grinder located within an outer grinder.

17. A multi-compartment spice grinder comprising:
a container comprising a cylindrical sidewall having an upper end and a lower end, the cylindrical sidewall forming a hollow receiving space;
a multi-partition component received within the hollow receiving space of the container, the multi-partition component having a plurality of walls forming separate compartments;
a clutch mechanism for a compartment formed by the plurality of walls, the clutch mechanism comprising:
a first clutch;
a second clutch secured in the first clutch; and
a spring located below a bottom of the first clutch; and
a bottom stopper configured to be received with the container, the bottom stopper having a plurality of slits configured to receive the plurality of walls;
a upper cap configured to be received over the container, the upper cap having a lower portion integrally connected to a lower portion;
a grinding mechanism secured to and extending outward from the upper cap, the grinding mechanism comprises:
a static component integrally connected to an upper portion of the upper cap;
a rotatable component rotatably secured to the upper portion of the upper cap; and
a top cap secured within the rotatable component; and
a lower cap threadingly engaged with the lower end of the container.
wherein the rotatable component is a grinding knob and wherein the grinding mechanism comprises an inner grinder located within an outer grinder.

18. The multi-compartment spice grinder of claim 17, wherein the multi-partition component comprises a plurality of elongated walls, each elongated wall in the plurality of walls comprises a horizontal bottom wall member, a first vertical side member extending upwardly from a first end of the bottom wall member and a second vertical side member extending perpendicularly upward from a second end of the bottom wall member.

19. The multi-compartment spice grinder of claim 18, wherein the second vertical side member of each elongated wall in the plurality of walls is integrally connected to form the multi-partition component.
